(19) United States
(12) Patent Application Publication
(10) Pub. No.: US 2015/0332030 A1
(43) Pub. Date: Nov. 19, 2015

(54) System for Locking Down a Computing Device for Restricted Access to End Users

(71) Applicant: 42Gears Mobility Systems Private Limited, Bangalore (IN)

(72) Inventors: Onkar Singh Parhar, Bangalore (IN); Prakash Gupta, Bangalore (IN); Pranay Choudhary, Bangalore (IN); Bhanderi Rinkalkumar Pravinbhai, Rajkot (IN)

(73) Assignee: 42Gears Mobility Systems Private Limited, Bangalore (IN)

(21) Appl. No.: 14/665,370

(22) Filed: Mar. 23, 2015

(30) Foreign Application Priority Data
May 15, 2014 (IN) 2422/CHE/2014

(51) Int. Cl. G06F 21/31

(52) U.S. Cl. CPC G06F 21/31

(57) ABSTRACT

The present invention discloses system for locking down the computing devices for restricted access to end users. The system includes a lock down module, a monitoring module and a single application module. The system using these modules blocks a user's access to at least one of a plurality of unallowed applications and restricts user's access to modify a peripheral setting like GPS, Airplane Mode, Bluetooth®, etc. The system allows only the desired applications to run and no other application is visible on the device. If the user tries to access an unallowed application through any means, it is immediately terminated. Computing device peripheral settings are locked down to desired value so that the users cannot change the settings.

### BACKGROUND OF THE INVENTION

With the huge number of smartphones and tablets available today, enterprises are finding innovative use of these devices in their businesses which includes: handing over one or more devices to their employees to enable them to work from the field or to mount the device(s) in public locations as display/interactive kiosks to engage with their customers. These devices have seen huge adoption in education as well. Many schools and colleges are using tablets, which enable their students to experience a new way of learning. These devices have great computing capabilities, connectivity, attractive display screens, and intuitive user interfaces, which make them ideal for these use cases.

While these feature-rich devices have all the features required for businesses, device manufacturers have also designed these devices for the common consumer for their daily personal needs. Users of these devices have uncontrolled access to the Internet through browser applications, and can install games and other leisure applications for their fun. Users can also accidently disturb some important device settings like turning off peripherals like Wi-Fi, GPS, Data, Bluetooth® which are vital for business applications and which can disrupt normal process. Such usage would be highly detrimental and result in poor productivity for businesses who intend to use these devices only for specific purposes.

### SUMMARY OF THE INVENTION

What is needed is a system that locks down access to unallowed applications and the computing device peripheral settings, so that the users cannot access and change the settings, and so that only the desired applications can be accessed by users.

Embodiments of the present invention include a system for locking down peripheral settings and applications on a computing device.

According to an embodiment of the present invention, a system locks down computing devices for restricted access to end users. The system includes a lock down module, a monitoring module, and a single application module. The system uses these modules to restrict a user's access to at least one of a plurality of unallowed applications and to restrict the user's access to modify a peripheral setting, such as one or more of GPS, Airplane Mode, and Bluetooth® on a computing device. The system allows only the desired applications to run on the computing device and makes other applications not visible on the computing device. If the user attempts to access an unallowed application, then the unallowed application is immediately terminated. Computing device peripheral settings are put into a desired lockdown state so that the users cannot change those settings.

In one embodiment of the present invention, the lock down module presents a user interface restricting a user's access to plurality of unallowed applications and restricting the user's access to modify a peripheral setting on the computing device.

In one preferred embodiment of the present invention, the monitoring module monitors the plurality of applications running on the computing device and sends one or more signals to an operating system to terminate the application, when the monitoring module detects that an unallowed application is being run by the users or by any external events.

In one embodiment of the present invention, the single application module allows a computer administrator to configure a single application to run on the computing device as a foreground application all the time. The single application module, with the help of the monitoring module, monitors and sends one or more signals to the operating system to terminate other applications and to bring a single application to the foreground, when the other applications are attempted to run by the user or by external events on the computing device. The system registers with the operating system so that when computing device is powered on, only the single application defined by computer administrator gets invoked automatically and presented to the user on the computing device.

According to another embodiment of the present invention the monitoring module further monitors the computing device peripheral settings and sends one or more signals to the operating system to retain the predefined settings made by a computer administrator, when the user or the external event attempts to change the computing device peripheral settings.

According to another embodiment of the present invention, the lock down module authenticates only the computer administrator to enter configuration mode, in which the computer administrator can specify which applications are allowed for user access and to define desired a lockdown state of peripheral settings.

According to another embodiment of the present invention, the lock down module allows incoming/outgoing call or Short message service (SMS) only for whitelisted numbers and blocks incoming/outgoing calls or SMS for blacklisted numbers. The whitelisted and blacklisted numbers are configured by the computer administrator.

In embodiments of the present invention, computing devices may include, for example, a desktop, laptop, cell phone, PDA, tablet, TV stick, etc , running any one or more operating systems in any combination, such as Android, iOS, Windows, or Symbian.

Hence, in embodiments of the present invention, the locked down module user interface covers an entire computing device display area (in some cases attached display device) and allows users to access only the allowed applications on the computing device. Any attempt to access an unallowed application by the user or by external events is detected by the present invention and locked down. Embodiments of the present invention restrict user's access to modify a peripheral setting such as any one or more of GPS, Airplane Mode, and Bluetooth® on the computing device. Furthermore, embodiments of the present invention may detect and block any incoming or outgoing calls or SMS from unallowed numbers.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1(a) and FIG. 1(b) illustrates the method flow involved in lockdown of unallowed applications on the computing device.

FIG. 2 illustrates the method flow involved in lockdown of peripheral settings on the computing device.

FIG. 3(a) and FIG. 3(b) illustrates the method flow involved in lockdown of single application mode on the computing device.

FIG. 4 illustrates the method flow involved in lockdown of unallowed call on the computing device.

FIG. 5 illustrates the method flow involved in lockdown of unallowed SMS on the computing device.

### DETAILED DESCRIPTION OF THE INVENTION

Reference will now be made in detail to the description of the present subject matter, one or more examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

The present invention discloses a system for locking down the computing devices for restricted access to end users. The system includes a lock down module, a monitoring module and a single application module. The system using these modules blocks a user's access to at least one of a plurality of unallowed applications and restricting user's access to modify a peripheral setting like GPS, Airplane Mode, Bluetooth® etc. on a computing device. The system allows only the desired applications to run and no other application is visible on the computing device. If the user attempts to access an unallowed application, then the unallowed application is immediately terminated. Computing device peripheral settings are defined to desired lockdown state so that the users cannot change the settings.

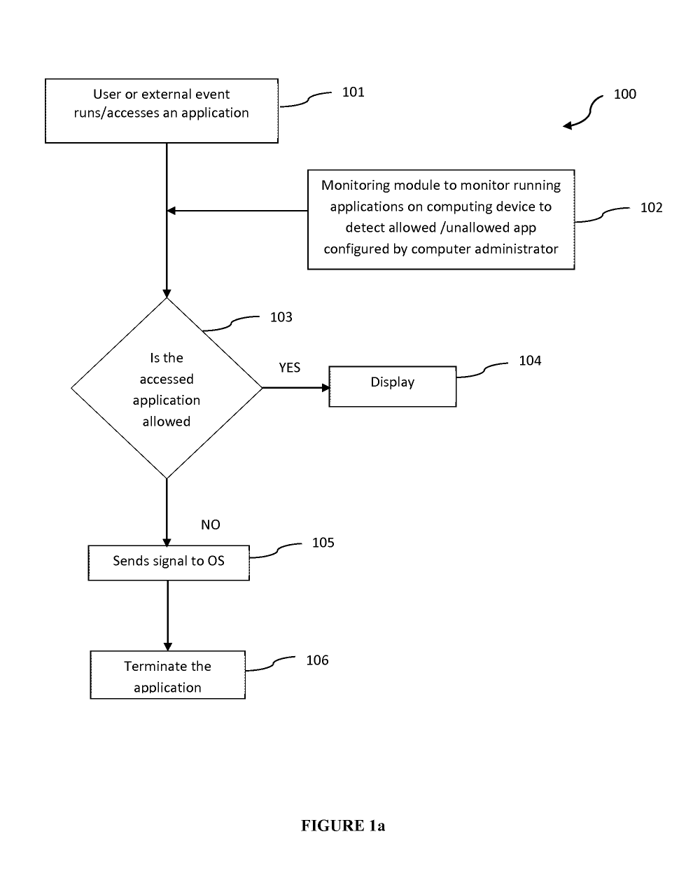

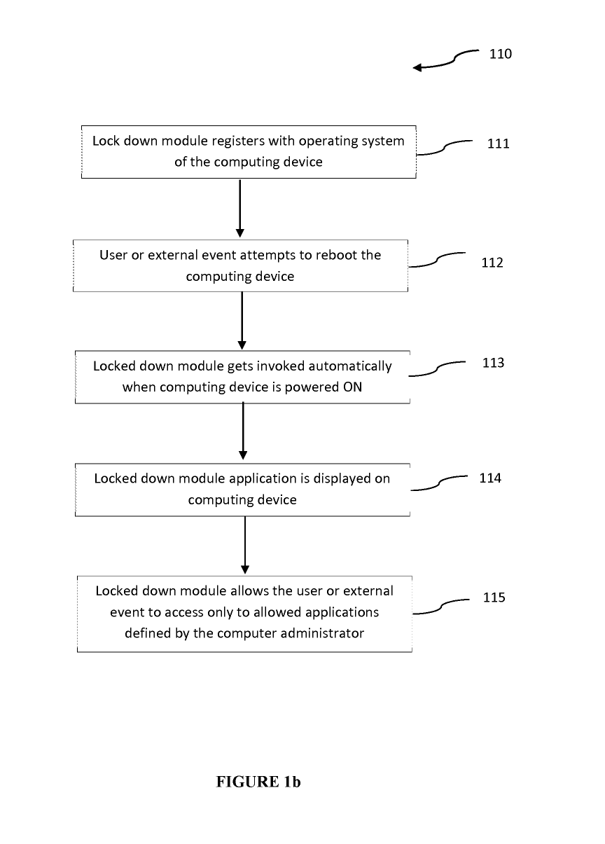

FIG. 1(a) illustrates the method flow 100 involved in lockdown of unallowed applications on the computing device. At step 101 user or any external event attempts to run the application on the computing device. At step 102 monitoring module monitors whether the application run by user or external event is allowed or unallowed. The step 103 defines, if the user or external event runs allowed application then the application is displayed at step 104 on the computing device in which the user is allowed to access and if the user or external event runs unallowed application then the present system sends the signal to operating system at step 105 and the lock down module restricts the user's access to the un allowed application and terminates the application shown in the step 106.

In the present system the lock down module authenticates only the computer administrator to enter configuration mode, in which the computer administrator can specify which applications are allowed to access.

FIG. 1(b) illustrates the method flow 110 involved in lockdown of unallowed applications on the computing device. At step 111 lock down module registers with operating system of the computing device. At step 112 user or external event attempts to reboot the computing device. At step 113 locked down module gets invoked automatically when computing device is powered ON. At step 114 locked down module application is displayed on computing device. At step 115 locked down module allows the user or external event to access only to allowed applications defined by the computer administrator.

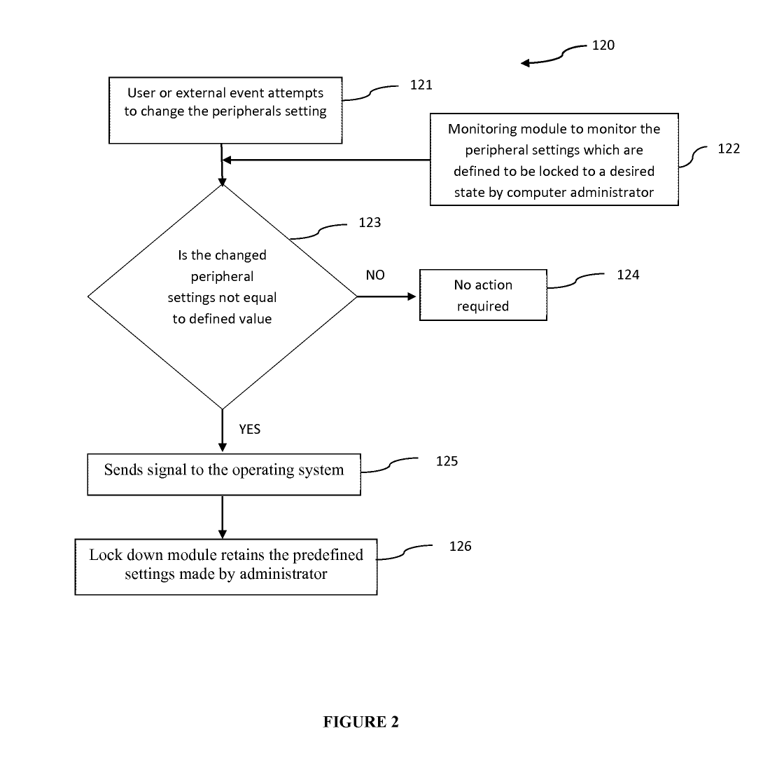

FIG. 2 illustrates the method flow 120 involved in lockdown of peripheral settings on the computing device. At step 121 user or external event attempts to change the peripheral settings on the computing device. At step 122 monitoring module monitors whether the peripheral setting changed by user or external event is not equal to desired value. The step 123 defines, if the user or external event changes the peripheral setting which are not defined to the desired state then there is no action required at step 124 on the computing and if the user or external event changes the peripheral setting like GPS, Airplane Mode, Bluetooth® etc., which are defined to the desired state then the present system sends the signal to operating system at step 125 and the lock down module retains the predefined settings made by computer administrator and restricts user's access to modify a peripheral setting on a computing device as shown in the step 126.

In the present system the lock down module authenticates only the computer administrator to enter configuration mode, in which the computer administrator can define desired lockdown state of peripheral settings.

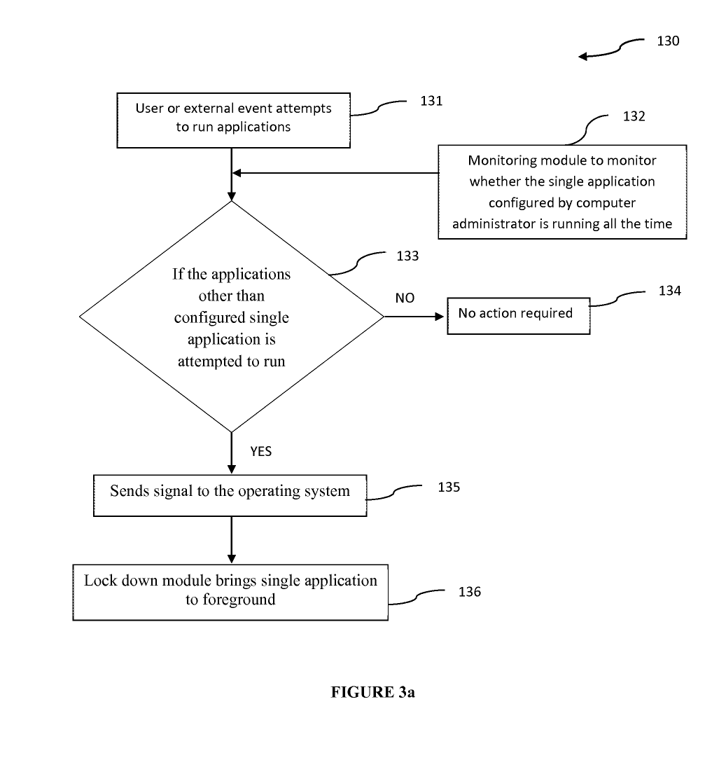

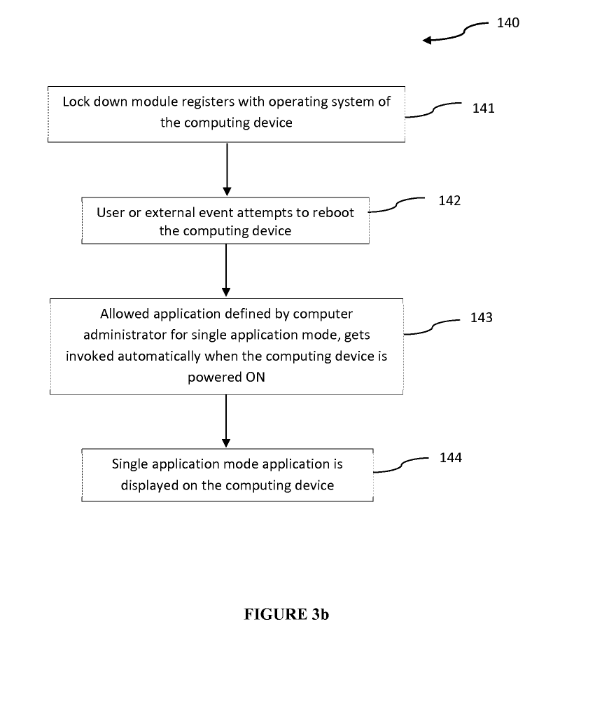

FIG. 3(a) illustrates the method flow 130 involved in lockdown of single application mode on the computing device. At step 131 user or external event attempts to run the applications on the computing device. At step 132 monitoring module monitors whether a single application configured by computer administrator is running all the time. The step 133 defines, if the applications other than configured single application is attempted to run then the present system sends signal to operating system at step 135 and the lock down module brings single application to foreground, terminating other applications as shown in the step 136.

In the present system the lock down module permits to authenticate only the computer administrator to enter configuration mode, in which the computer administrator can define an application to be run in single application mode.

FIG. 3(b) illustrates the method flow 140 involved in lockdown of single application mode on the computing device. At step 141 the lock down module registers with operating system. At step 142 user or external event attempts to reboot the computing device. At step 143 the allowed application defined by computer administrator as single application mode application, gets invoked automatically when the computing device is powered ON. At step 144 the single application mode application is displayed on the computing device.

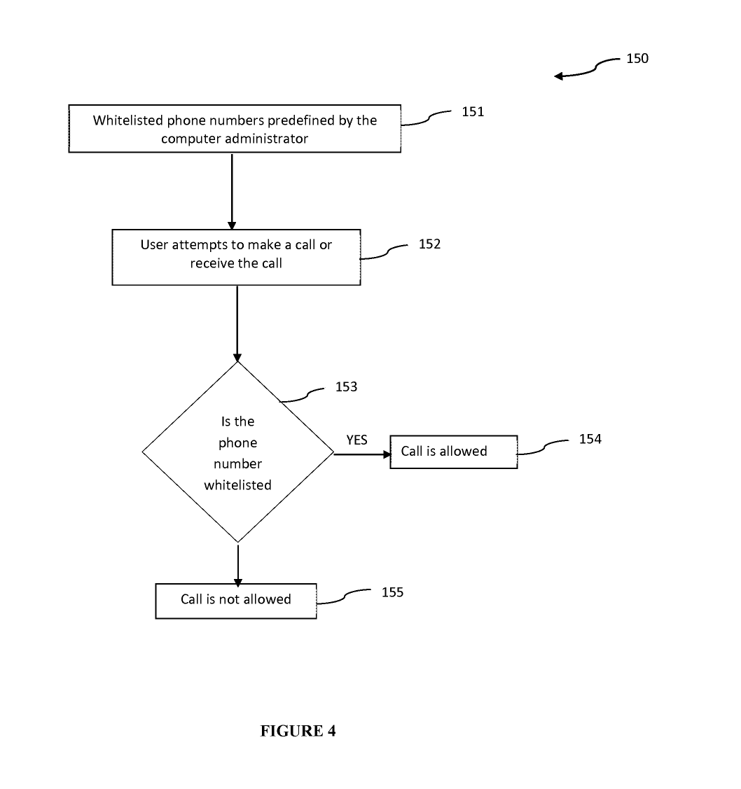

FIG. 4 illustrates the method flow 150 involved in lockdown of unallowed call on the computing device. At step 151 plurality of whitelisted phone numbers are predefined by the computer administrator. At step 152 user attempts to make a call or receive a call on computing device. The step 153 defines, if the called number is whitelisted then the call is allowed at step 154 and if the called number is not whitelisted then the call is not allowed at step 155.

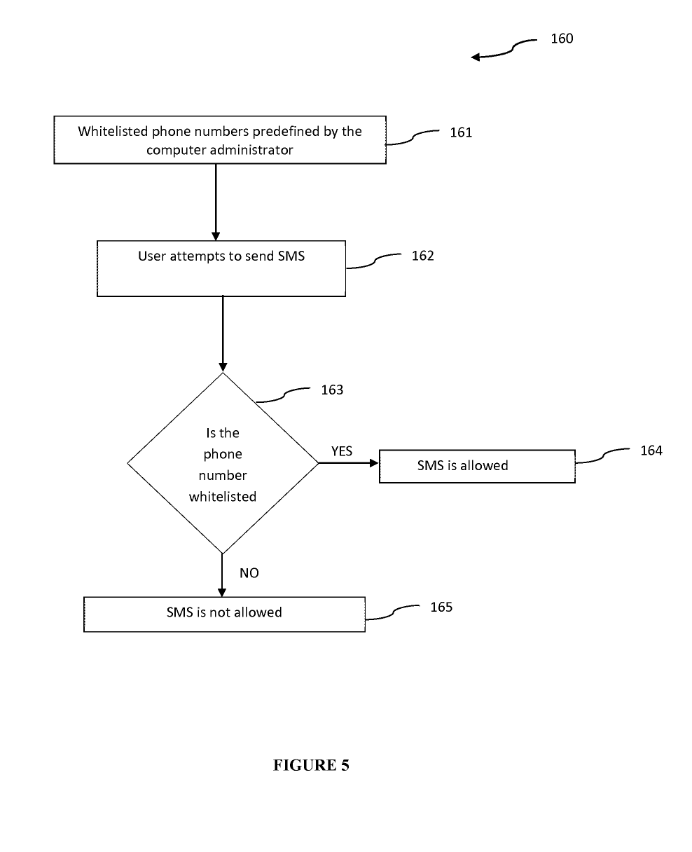

FIG. 5 illustrates the method flow 160 involved in lockdown of unallowed SMS on the computing device. At step 161 plurality of whitelisted phone numbers are predefined by the computer administrator. At step 162 user attempts to send SMS or receive SMS on computing device. The step 163 defines, if the number is whitelisted then the SMS is allowed at step 164 and if the number is not whitelisted then the SMS is not allowed at step 165.

The present invention disables all the ways of exiting for the user from lock down module on the computing device, such as pressing back button, pressing home button, pressing Alt+F4, rebooting device etc.

The term “Computing device” used herein refers to a desktop, laptop, cell phone, PDA, tablet, TV stick running plurality of operating systems such as android, ios, windows, Symbian etc.

The term “external event” used herein refers to a periodic change caused automatically according to the position of computing device. For example if the computing device comes in contact with the Bluetooth® enabled area then an automatic periodic change occurs in the computing device wherein the device gets paired with other computing device and changes the status of computing device. The term “external event” may also be referred as a new incoming call, new incoming SMS, new incoming chat, new incoming mail, software update, battery notification, alarm trigger, location update, gain/loss of bluetooth/WiFi/Cellular connectivity, etc.

In the present invention the locked down user interface covers entire computing device display area or any other attached display device and allows users to access only the allowed applications on the computing device. Any attempt to access an unallowed application by the user or by external events is detected by the present invention and the access is declined. The present invention restricts user's access to modify a peripheral setting like GPS, airplane mode, Bluetooth®, etc. And also any incoming/outgoing calls or SMS from unallowed numbers is detected and blocked.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. Furthermore, embodiments of the present invention solve problems which are inherent to computers, such as the problem of blocking access to features on a computing device. The solutions provided by embodiments of the present invention to such problems, therefore, represent improvements to computers and solutions to computer-inherent problems, and do not constitute techniques for organizing human activity.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A system for locking down the computing devices for restricted access to end users, the system comprises of:
a) a lock down module which presents a user interface restricting user's access to plurality of unallowed applications and restricting user's access to modify a peripheral setting on a computing device;
b) a monitoring module monitors the plurality of applications running on the computing device and sends signal to operating system to terminate the application, when the monitoring module detects the unallowed application is being run by the user or external events;
c) a single application module allows a computer administrator to configure a single application to run on the computing device as a foreground application all the time; and
d) the single application module with the help of the monitoring module monitors and sends signal to operating system to terminate other applications and bring single application to foreground, when the other applications are attempted to run by the user or by external events on the computing device.

2. The system of claim 1, wherein said lock down module permits to authenticate to enter configuration mode, in which the computer administrator can specify which applications are allowed for user access and define desired lockdown state of peripheral settings.

3. The system of claim 1, wherein said external events may be a new incoming call, new incoming SMS, new incoming chat, new incoming mail, software update, battery notification, alarm trigger, location update, gain/loss of bluetooth/WiFi/Cellular connectivity, etc.

4. The system of claim 1, wherein said lock down module registers with operating system so that when computing device is powered on, only the single application defined by computer administrator gets invoked automatically and presented to the user on the computing device.

5. The system of claim 1, wherein said system disables all the ways of exiting from lock down module on the computing device, such as pressing back button, pressing home button, pressing Alt+F4, rebooting, etc.

6. The system of claim 1, wherein said system allows incoming/outgoing call/sms only for whitelisted numbers and blocking incoming/outgoing calls/sms for blacklisted numbers.

7. The system of claim 6, wherein said whitelisted and blacklisted phone numbers are predefined by the computer administrator.

8. The system of claim 1, wherein said computing device may be a desktop, laptop, cell phone, PDA, tablet, TV stick running plurality of operating systems such as android, ios, windows, Symbian etc.

9. The system as claimed in claim 1, wherein the monitoring module further monitors the computing device peripheral settings and sends signal to the operating system to retain the predefined settings made by computer administrator, when the user or the external event attempts to change the computing device peripheral settings.
